(19) United States
(12) Patent Application Publication
(10) Pub. No.: US 2006/0124886 A1
(43) Pub. Date: Jun. 15, 2006

(54) Gate valve

(76) Inventor: Arthur J. Brenes, Reno, NV (US)

Correspondence Address: David J. Brezner;Dorsey & Whitney LLP, Intellectual Property Department, 555 California Street, Suite 1000, San Francisco, CA, 94104-1513, US

(21) Appl. No.: 11/178,227

(22) Filed: Jul. 7, 2005

Related U.S. Application Data
(60) Provisional application No. 60/586,935, filed on Jul. 8, 2004.

(51) Int. Cl. F16K 3/00

(52) U.S. Cl. 251/326

(57) ABSTRACT

A gate valve includes a housing, a gate support positioned within the housing, a gate connected to the gate support, and first and second actuators that control movement of the gate support and gate. The housing defines a valve chamber having first and second aligned openings for passage of air between first and second housing side walls. The gate support is reciprocable between a first support position remote from said openings and a second support position between said openings. The gate is transversely reciprocable between a first gate position spaced from said openings and a second gate position sealing off the first opening. The actuators move the gate support between first and second support positions and move the gate between first and second gate positions. The gate support is spaced apart from the second side wall of the housing when the gate is in the first and second gate positions.

### CROSS-REFERENCES TO RELATED APPLICATIONS

This application claims priority to U.S. Provisional Patent Application No. 60/586,935 filed Jul. 8, 2005, entitled GATE VALVE, the entire contents of which is incorporated herein by this reference.

### BACKGROUND OF THE INVENTION

1. Field of the Invention

The present invention pertains to gate valves or slot valves of the type used in vacuum contained automated substrate handling systems, such as may commonly be employed in modular robotic wafer fabricating systems.

2. Description of Related Art

In the semiconductor industry, automated silicon wafer substrate handling systems are utilized to move wafers into and out of process modules that perform various operations on the wafers, such as vapor deposition, ionization, etching, etc. These handling systems are commonly referred to as cluster tools, and an example of such a system is the Marathon Series cluster platforms available from Brooks Automation, Lowell, Mass., USA.

The processes performed on the wafers are done within vacuum chambers, and the cluster platforms and associated equipment are housed in “clean” rooms, the environments of which are strictly controlled. Vacuum chambers and clean rooms are utilized in order to prevent the smallest of particles from being introduced into the wafer matrices In addition, the wafer processing equipment of cluster tools is designed for low particulate generation through millions of cycles of operation. To achieve ultrapure fabrication techniques, processing equipment is employed that has a minimum of moving parts, and to further prevent particle contamination, machine componentry is properly isolated and sealed.

With clean rooms, space utilization is of utmost importance, as the costs for operating a clean room are extremely expensive. Accordingly, there is an advantage in providing more efficient equipment in less space, in order to lower manufacturing costs.

Gate valves (or slot valves) are commonly employed to provide vacuum seals at numerous locations between modular integrated processing equipment. For example, gate valves are positioned between wafer cassette modules and central handling modules, and between central handling modules and process modules. Gate valves open to allow transfer of wafers between modules, and close to seal off modules so that vacuum controlled processes may be performed within the modules.

Present gate valve assemblies include generally a gate valve housing and an actuator housing with associated controls. While these gate valve designs provide narrow profiles, allowing closely adjacent positioning of cooperating modules, the height of such gate valve assemblies can be extensive, which causes space utilization concerns below the processing equipment where associated controls and pumps are positioned.

One problem with existing gate valves is the introduction of particulates into the modules from the valve itself. Whenever moving parts of valves, such as metal parts, contact each other, it is possible for such contact to contribute to particulate generation, that is, microscopic particles released from the valve from such contact and introduced into the modules. It is desirable to minimize introduction of particulates into the modules to maintain ultrapure fabrication techniques.

### BRIEF SUMMARY OF THE INVENTION

One aspect of the present invention is directed to a gate valve including a valve housing, a gate support positioned within the valve housing, a valve gate connected to the gate support, and first and second actuators that control movement of the gate support and gate. The valve housing defines a valve chamber having first and second aligned openings for passage of air along a flow path between a first side of the valve housing and a second side of the valve housing. The gate support is reciprocable within the valve housing between a first support position remote from said openings and a second support position between said openings. The valve gate is transversely reciprocable within said support between a first gate position spaced from said openings and a second gate position sealing off the first opening. The first actuator moves the gate support between first and second support positions. The second actuator is carried on the gate support and moves the gate support between first and second gate positions. The gate support is spaced apart from the second side of the housing when the valve gate is in the first and second gate positions.

Another aspect of the present invention is directed to a gate valve having a valve housing that defines a valve chamber. The valve housing has first and second aligned openings for passage of air along a flow path between a first side of the valve housing and a second side of the valve housing, wherein the first and second sides are formed from a single contiguous piece of material. A gate support is reciprocable within the valve housing between a first support position remote from said openings and a second support position between said openings. The valve further includes a valve gate including a seal transversely reciprocable within said support between a first gate position spaced from said openings and a second gate position sealing off the first opening. A first actuator within the valve chamber moves the gate support between first and second support positions. A second actuator carried on the gate support that moves the gate support between first and second gate positions.

Yet another aspect of the present invention is directed to a gate valve having a two-piece housing that defines a valve chamber. The housing includes a first housing piece formed from a single contiguous piece of material that forms first and second parallel sides, the sides having defined therein first and second aligned openings, respectively, wherein the first and second openings form a central opening in the valve that allows air flow between the first side and the second side along a flow path. The housing also includes a second housing piece that forms a bottom plate detachably connected to a lower end of the first housing piece, wherein removal of the second housing piece provides access to the valve chamber. A valve gate reciprocates between open and closed positions of the valve. The valve gate is positioned in the central opening in sealing contact with the first side of the housing to cover the first opening when the valve is in a closed position. The valve gate is positioned remote from the central opening and spaced apart from the first side of the housing when the valve is open. A first actuator moves the valve gate between a first support position in the central opening and a second support position remote from the central opening. A second actuator moves the valve gate between a first position in sealing contact with the first side of the housing in which the first opening is covered and a second position in which the gate is spaced apart from the first side of the housing. A gate support supports the valve gate, and the gate support is spaced apart from the housing when the valve is in the open and closed positions.

The gate valve of the present invention has other features and advantages which will be apparent from or are set forth in more detail below.

### BRIEF DESCRIPTION OF THE DRAWINGS

The Detailed Description of the Invention will refer to the following drawings, wherein like numerals refer to like elements, and wherein:

FIG. 1 shows a perspective view of a gate valve;

FIG. 2 shows a perspective view of the valve shown in FIG. 1, illustrating the underside of the valve;

FIG. 3 shows a perspective view of the valve shown in FIG. 1, with the valve 10 in a closed position;

FIG. 4 shows a partial cross-section of the valve shown in FIG. 1, with the valve in the open position, showing the interior valve chamber;

FIG. 5 shows the interior valve chamber of the valve shown in FIG. 1, with the valve in the closed position;

FIG. 6 is a more detailed cross-section of the valve as shown in FIG. 4, in the open position taken along line 6-6 of FIG. 7;

FIG. 7 shows a cross-section of the valve shown in FIG. 6, taken along the line 7-7 of FIG. 6;

FIG. 8 shows a cross-section of the valve shown in FIG. 6, taken along the line 8-8 of FIG. 6;

FIG. 9 shows a cross-section of the valve shown in the closed position seen in FIG. 5;

FIG. 10 shows a cross-section of the valve shown in FIG. 9, taken along the line 10-10 of FIG. 9;

FIG. 11 shows a cross-section of the valve shown in FIG. 9, taken along the line 11-11 of FIG. 9;

FIG. 12 shows a top view of the valve shown in FIG. 1;

FIG. 13 shows a cross-section of the valve shown in FIG. 1, taken along the line 13-13 of FIG. 6;

FIG. 14 shows a cross-section of the valve shown in FIG. 6, taken along the line 14-14 of FIG. 6;

FIG. 15 shows an enlarged, more detailed view of an upper portion of the cross-section of the valve shown in FIG. 6, with the valve in the open position;

FIG. 16 shows a cross-section of the valve shown in FIG. 6, taken along the line 16-16 of FIG. 6, with the valve in the open position; and

FIG. 17 shows a cross-section of the valve shown in FIG. 9, taken along the line 17-17 of FIG. 9, with the valve in the closed position.

FIG. 18 shows an enlarged cross-section of a portion of modified a gate valve similar to that shown in FIG. 15.

FIG. 19 shows an enlarged cross-section of the gate valve of FIG. 18 taken along line 19-19 of FIG. 18.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

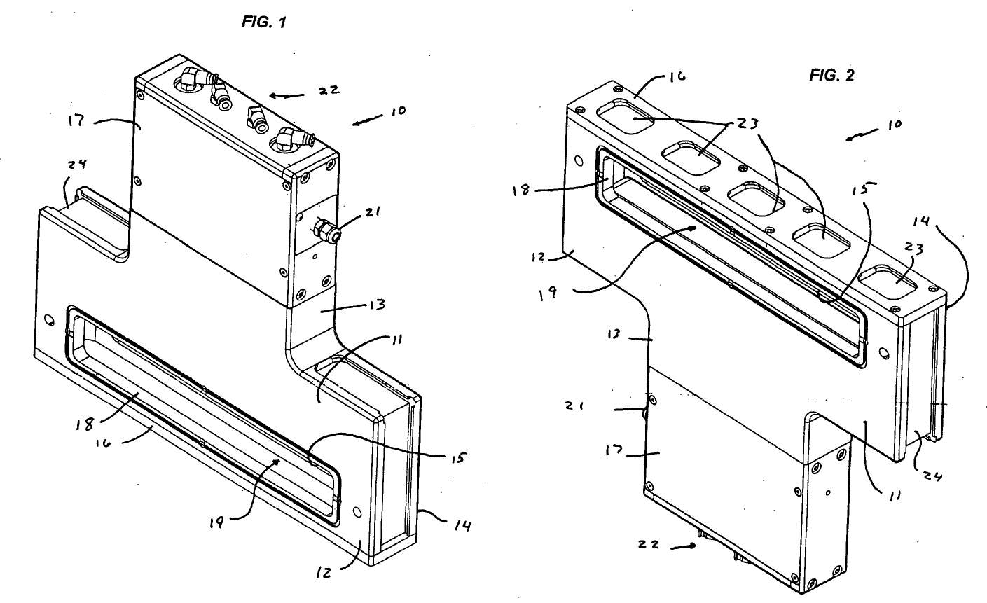

Turning now to the drawings, wherein like components are designated by like reference numerals throughout the various figures, attention is directed to FIG. 1 which shows a perspective view of a gate valve 10. In some aspects, some components of the gate valve of the present invention, are similar to those of the valves that that are described in U.S. Pat. Nos. 5,881,998 and 5,975,492, both to Brenes, the entire content of which patents is incorporated herein by this reference.

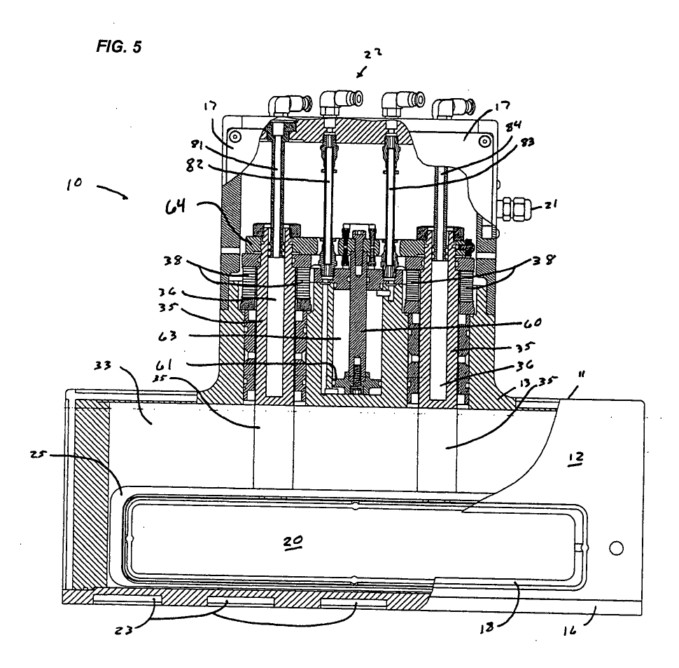

Generally, the valve 10 of the present invention includes a valve gate 20 that is carried on a strongback 25 and reciprocally moved between a raised open position (e.g., FIG. 4) and a lowered closed position (e.g., FIG. 5). The valve gate is also reciprocally movable in a transverse direction with respect to the strongback such that valve gate 20 can be moved from a first disengaged gate position, as shown in FIG. 7, to a second engaged gate position, as shown in FIG. 10. Unlike prior gate valves, the strongback 25 is unsupported within a valve chamber 33 defined by the valve housing 13, that is, there is no contact between the strongback 25, or its supporting structure, and the internal surfaces of the valve housing 13. Such configuration serves to minimize particulate generation within the valve chamber 33. Additionally, the housing includes a first, main-enclosure portion 11 and a removable second, bottom-plate portion 16 which provides ready access to the valve assembly including the valve gate 20, strongback 25 and the components for moving the valve plate relative to the strongback. In fact, removable the configuration of the bottom plate portion 16 allows the valve gate 20 and strongback 25 to be simply removed from the housing 13 as an assembled unit. Furthermore, the bottom-loading configuration of the housing 13 eliminates “clam-shell” type seams in the housing thus providing a simplified configuration having fewer vacuum-quality seams.

The valve 10 includes a housing 13 and a control portion 17. Preferably, the housing 13 is formed from two pieces of material including, but not limited to aluminum, stainless steel and other suitable materials. The first portion or main enclosure 11 of the housing 13 is a single contiguous piece of material having first and second sides 12, 14. Preferably, first portion 11 is monolithically formed by suitable means including, but not limited to, CNC machining, and/or casting. The sides 12, 14 are substantially flat and parallel to each other. The first and second sides 12, 14 each define first and second elongated rectangular openings 18, 15, respectively. The openings 18, 15 are aligned and together define a central opening 19 in the housing 13, through which robotic wafer or flat panel handling equipment can move to transfer wafers or the like between a transfer module and various process modules. The aligned openings 18, 15 forming the central opening 19 also define a flow path through housing 13 through which gases move as adjacent module chambers are evacuated. In the example of FIG. 1, the valve 10 is shown in an open position in which the flow path through the central opening 19 is open.

The housing 13 defines a valve chamber (not shown in FIG. 1) that contains actuator assemblies that open and close the valve 10. In the illustrated embodiment, the actuator assemblies are pneumatically controlled, however, one will appreciate that other suitable means including, but not limited to electric solenoids and motors, may also be used in accordance with the present invention. Pneumatic fittings 22 are shown generally, in fluid communication with the control portion 17 of the valve 10. A strain relief valve 21 is also shown in fluid communication with the control portion 17 to relieve excess pressure within the valve chamber.

The second portion or detachable bottom plate 16 of the housing is a substantially flat rectangular bottom plate that detachably connects to the lower end of the first portion 11 of the housing 13. The single piece construction of the first portion 11 of the housing 13 minimizes contact between materials proximate the central opening 19, which in turn minimizes particulates introduced into the central opening 19 by the valve 10. The detachable bottom plate 16 of the housing 13 provides access to the valve chamber (not shown) and to the actuator assemblies (not shown) contained therein. This access allows replacement and maintenance of the actuators and other components of the valve 10 contained within the valve chamber, through the lower end of the valve housing 13. In particular and unlike prior valves, the configuration of bottom plate 15 does not require “clam shell” separation of the housing and thus, in some instances, may allow access to the valve chamber while the housing remains installed.

The top portion 11 of the housing 13 includes a series of recesses 24 that include inwardly directed flanged rims, which cooperate with various types of clamp mechanisms to secure the valve 10 in position between system modules.

FIG. 2 shows a perspective view of the valve 10 shown in FIG. 1, illustrating the underside of the valve 10. The bottom plate 16 includes recesses 23 that cooperate with various types of clamp mechanisms to secure the valve 10 in position between system modules.

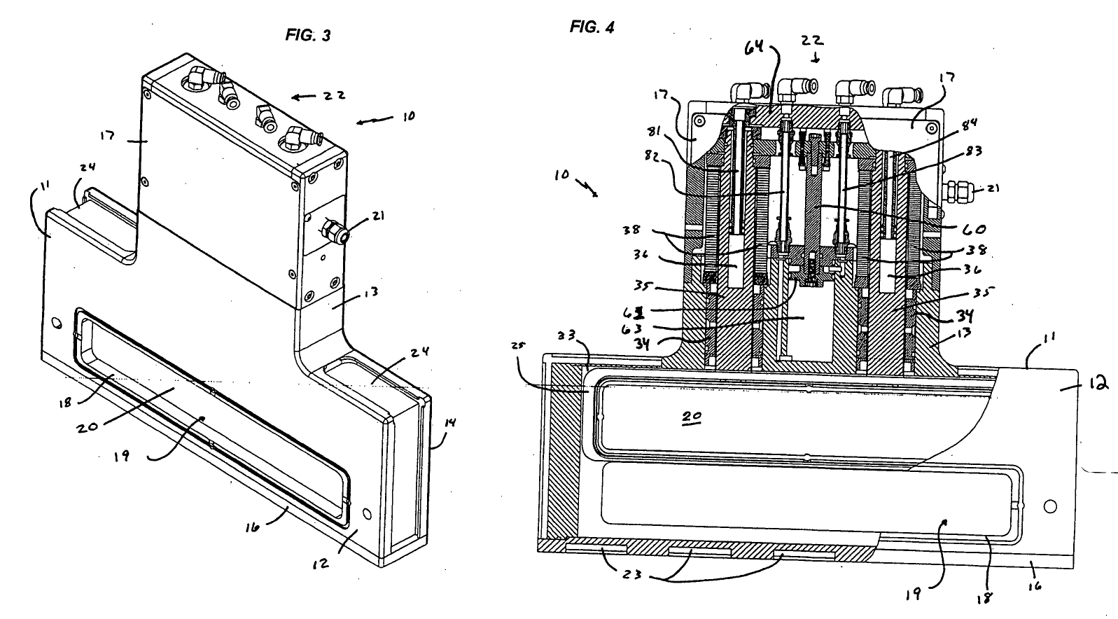

FIG. 3 shows a perspective view of the valve 10 shown in FIG. 1, with the valve 10 in a closed position. As shown in FIG. 2, a gate 20 seals the first opening 18 of the housing 13, thereby closing the valve 10. As explained further herein, the valve gate 20 is mounted on gate support (not shown in FIG. 2). The gate support is controlled by pneumatic controls. To move the valve 10 from an open position to a closed position, the controls cause the gate support to move the valve gate 20 into the central opening 19, such that the gate 20 is aligned with the first opening 18, for example by moving the valve gate 20 longitudinally downward. After the gate 20 is in position in the central opening 19, pneumatic controls move the gate 20 transversely toward the first opening 18, thereby causing the gate 20 to seal the first opening 18 by pressing against the opening 18. The second actuator moves the gate 20 transversely relative to the gate support. The gate support is sufficiently rigid to allow the gate 20 to seal against the first opening 18 without causing the gate support to flex and press against the opposing side 14 of the valve housing 13. In particular, the gate support is sufficiently rigid to maintain its spaced apart position from the second side 14 of the valve housing 13 in both the closed and open position of the valve 10, which spaced-apart configuration minimizes contact between moving components of the valve 10 and thereby minimizes particulate generation within the valve chamber and the introduction of unwanted particulates into the valve opening 19, which could result from contact between moving parts of the valve 10.

FIG. 4 shows a partial cross-section of the valve 10 shown in FIG. 1, with the valve 10 in the open position, showing the interior valve chamber 33 the housing 13. The valve 10 in the example of FIG. 3 is a dual action valve that opens and closes in response to pneumatic pressure applied to the fittings 22. The valve 10 includes first and second actuators that open and close the valve 10. The first actuator selectively moves the gate 20 downwardly to block the central opening 19. In the example of FIG. 3, the first actuator moves the gate 20 longitudinally into position in the central opening 19. The second actuator moves the gate transversely toward the first side 12 of the housing 13, that is, toward the left as shown in FIG. 10, to cover and seal the first opening 18.

In the example of FIG. 4, the first actuator includes a piston assembly mechanically connected to two substantially vertical gate supports 35 of the gate support. The gate supports 35 are slidably mounted to the housing 13 by way of thrust bearings 34. The piston assembly moves the gate supports 35 up and down in response to pneumatic pressure applied through fittings 22 to “open” conduit 82 and “close” conduit 83, respectively. One will appreciate that one, two, three or more gate supports may be used depending upon the configuration of the valve plate. The piston assembly includes a piston rod 60 and a valve-support piston 61 moving within a piston chamber 63. As shown in FIG. 3, pneumatic pressure applied through open conduit 82 enters the piston chamber 63 below the valve-support piston 61 and causes the valve-support piston 61 and the attached piston rod 60 to move upward, in the orientation shown in FIG. 4. Movement of the valve-support piston 61 upward causes the gate supports 35 to move upward, thereby raising the gate 20 and opening the valve 10. Pneumatic pressure applied through close conduit 83 enters the piston chamber 63 above the valve-support piston 61 and causes the valve-support piston 61 and the attached piston rod 60 to move downward, in the orientation shown in FIG. 5. As the piston rod 61 is operably connected to the gate supports 35 by way of cross link 64, movement of the valve-support piston 61 downward causes the gate supports 35 to move downward, thereby lowering the gate 20 into the central opening 19. Expandable steel support bellows 38 isolate the pneumatically pressured chambers 36 from the pressure of the valve opening 19, which may be operated under vacuum pressure. In the example of FIG. 4 in which the valve 10 is open, the support bellows 38 are extended.

In the example of FIG. 4, the second actuator causes the gate 20 to move transversely toward (see, e.g., FIG. 10) or away (see, e.g., FIG. 7) from the first opening 18 in the first side 12 of the housing 13. Pneumatic pressure is applied to the second actuator through conduits 81, 84. The conduits 81, 84 fluidly connect to support passageways (37, 37′ in FIG. 8) defined in the gate supports 35. The support passageways 37, 37′ have a width that telescopically accommodates the conduits 81, 84. Pneumatic pressure applied through one of the fittings 22 to the disengage conduit 81 pressurizes the support passageways 37′ of the gate support 35 in fluid connection with the disengage conduit 81. The gate holder in FIG. 4 includes a rigid support structure referred to as a strongback 25 which serves as a base from which gate moves with respect to. The strongback 25 is mounted on the gate supports 35 and moves up and down within the valve chamber 33 as the first actuator moves the gate supports 35 up and down. The gate 20 is moveably mounted on the strongback 25. Pressure provided through the engage conduit 84 is provided through conduits (not shown in FIG. 4) to urge the gate transversely away from the strongback 25 (e.g., to the left as viewed in FIG. 10) into the closed position to seal the first opening 18, thereby closing the valve 10. Pressure provided through the disengage conduit 81 is provided through conduits (not shown in FIG. 4) to urge the gate transversely away from the opening 18 and toward to the strongback 25 into the open position, that is to the right as viewed in FIG. 7.

FIG. 5 shows the interior valve chamber 33 of the valve 10, with the valve 10 in the closed position. Comparing FIG. 5 with FIG. 4, pneumatic pressure has been applied through close conduit 83 to an upper portion of the piston chamber 63 causing the piston rod 60 to move downward and causing the gate supports 35 connected to the piston rod 60, by way of the cross link 64, to move downward. The strongback 25, connected to distal ends of the gate supports 35, has lowered into the central opening 19 of the valve 10. The gate 20, movably mounted on the strongback 25, has also has moved into the central opening 19. Pneumatic pressure has also been applied though engage conduit 84 to cause the pistons (not shown in FIG. 5) reciprocally connecting the gate 20 to the strongback 25 to extend, thereby causing the gate 20 to move transversely toward the first side 12 of the housing 13, that is, toward the left as shown in FIG. 10, to seal the first opening 18 and close the valve 10. In the closed position, the support bellows 38 are contracted relative to the position of the support bellows 38 in the open position shown in FIG. 4.

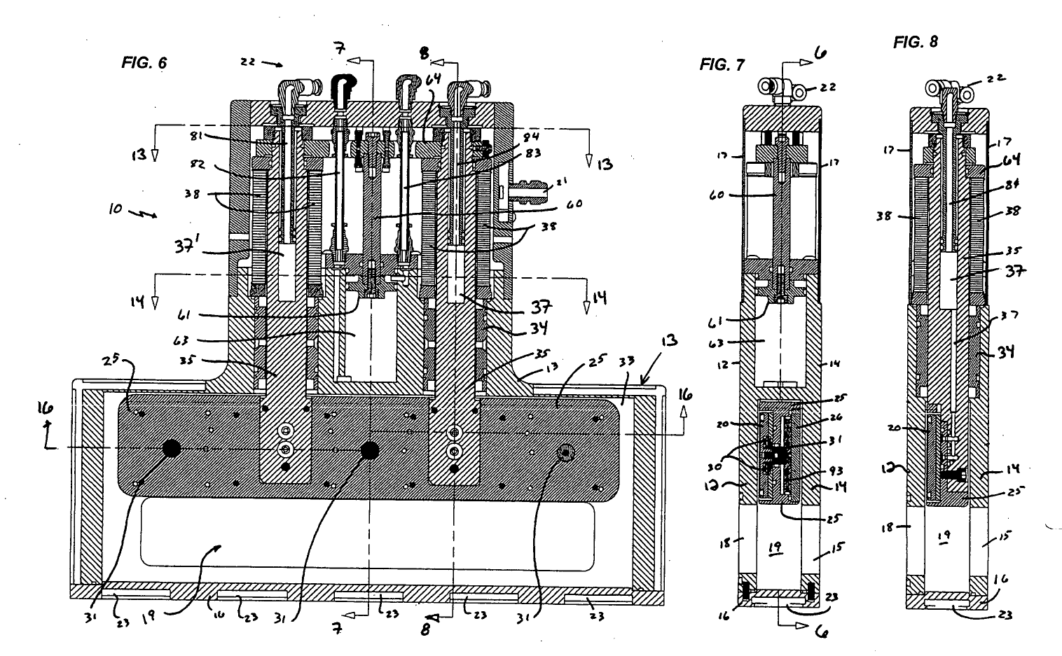

FIG. 6 is a more detailed cross-section of the valve 10 shown in FIG. 4, in the open position. In the open position, the strongback 25 is positioned in the upper portion of the valve chamber 33 away from the central opening 19, in the orientation of the valve 10 shown in FIG. 6. As shown in FIG. 6, the strongback 25 is fixedly connected to the gate supports 35. Three gate piston rods 31 reciprocally connect the valve gate 20 to the strongback 25, as shown in FIG. 7. The gate piston rods 31 are part of the second actuator in this example. In the open position shown in FIG. 7, the gate piston rods 31 are contracted such that the gate 20 is spaced away from the front side 12 of the housing 13.

With continued reference to FIG. 7, in the open position, central opening 19 of the valve 10 is open along a flow path between the first and second openings 18, 15 defined in the first and second sides 12, 14, respectively of the valve 10. As shown in FIG. 7, the valve-support piston 61 is positioned near the top of the piston chamber 63 thereby positioning the strongback 25 in the open position of the valve 10, in the orientation shown in FIG. 7. The gate 20 is spaced away from the first side 12 of the housing 13. The gate piston rod 31 and a gate piston 93 operably and reciprocally mount the valve gate 20 on the strongback 25. The strongback 25 includes a detachable access plate 26 that provides access to the gate piston assembly, which includes the gate piston rod 31 and the gate piston 93, for example, to replace or repair the gate piston assembly. The strongback 25 and other components of the gate support are spaced from the second side 14 of the valve housing 13 in both the open and closed positions of the valve 10. Such configuration elements metal to metal contact between the strongback and the housing, thus eliminating particulate generation due to such contact. Expandable steel gate bellows 30 isolate the pneumatic pressure applied to the gate piston rod 31 from the valve chamber in which the valve 10 operates, which may be at vacuum pressure, for example. One will also appreciate that the expandable bellows also serves to isolate any particulate generation which may occur by sliding contact of the piston rod from the valve chamber.

FIG. 8 shows a cross-section of the valve 10 shown in FIG. 6, taken along the line 8-8. In the open position, the support bellows 38 are extended when the gate support 35 is in the raised position, in the orientation of the valve 10 shown in FIG. 8. The support passageway 37 of the gate support 35 fluidly connects to the engage conduit 84 and the second conduit 37 of the gate support 35. The support passageway 37 provides pressure to the pistons (31 in FIG. 6) to move the gate 20 transversely away from the strongback 25 to seal the gate 20 over the first opening 12 to close the valve 10, in the closed position.

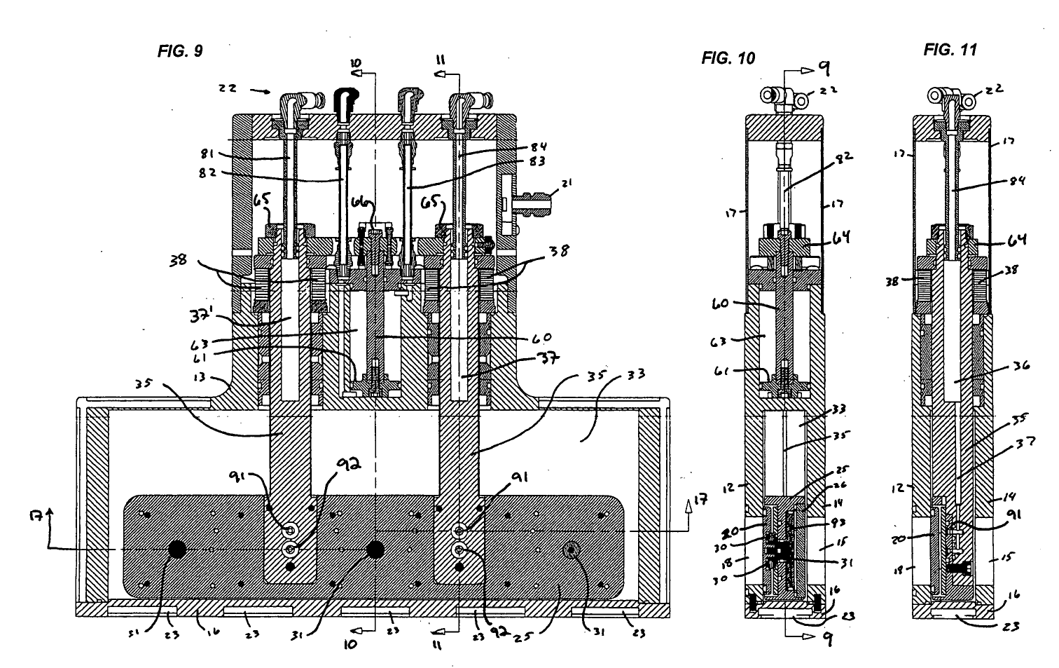

FIG. 9 shows a cross-section of the valve 10 shown in the closed position. Comparing FIG. 9 with FIG. 6, the strongback 25 has moved lower in the valve chamber 33 such that it now blocks the central opening (19 in FIG. 6). The gate piston rods 31 are extended to urge the gate (20 in FIG. 5) toward the first side 12 of the housing 13 to seal the first opening (18 in FIG. 5), thereby closing and sealing the valve 10.

FIG. 10 shows a cross-section of the valve 10 shown in FIG. 9, taken along the line 10-10. Comparing FIG. 10 with FIG. 7, the valve-support piston 61 has moved within the piston chamber 63 to lower the gate supports 35, the strongback 25, and the gate 20 into the central opening 19. The movement of the piston rod 60 has revealed open conduit 82, which provides pressure to the support piston chamber 63 to raise the gate support in this embodiment, as shown in FIG. 9. The gate piston rod 31 and the gate piston 93 have moved the gate 20 to the left in the orientation shown to cause the gate 20 to move toward and abut against the first side 12 of the housing 13, thereby covering sealing the first opening 18 and closing the valve. In the illustrated embodiment, the valve gate has a seal 41, for example, an elastomeric seal and/or other suitable means, to create a seal interface between the valve gate and the respective interior wall surfaces of first side 12 about the front opening. In the illustrated embodiment valve gate 20 is provided with an annular sealing groove which receives a rectangular valve ring 41. The gate bellows 30 expand as the gate piston rod 31 extends to close the gate 20 against the housing 13. In the example of FIG. 10, the strongback 25 is positioned near the bottom plate 16 in the closed position. The strongback 25 and the gate supports 35 are sufficiently rigid to allow the gate piston rods 31 to press against the strongback 25 to seal the gate 20 against the first side 12 of the housing 13 without causing the strongback 25 or other portions of the gate support to flex under pressure and contact the second side 14 of the valve housing 13 to minimize contact between moving parts of the valve 10. As shown in FIG. 10, the strongback 25 and other portions of the gate support are spaced from the second side 14 of the housing 13.

FIG. 11 shows a cross-section of the valve 10 shown in FIG. 9, taken along the line 11-11 illustrating the fluid connection of second actuator conduit 84 to the piston chamber (94 in FIG. 10) of the gate piston. In particular, second actuator conduit 84, by way of the support passageway 37, is in fluid connection with gate-engage passageway 91, which extends through the strongback 25 and feeds the rear side of each gate piston chamber. Although not shown, second actuator conduit 81 is similarly connected to the piston chamber of the gate piston in order to disengage the valve gate 20. In particular, second actuator conduit 84, by way of the support passageway support passageway 37′, is in fluid connection with gate-disengage passageway 92, which also extends through the strongback 25 and feeds the front side of each gate piston chamber. In the illustrated embodiment, the gate supports 35 are substantially identical. Accordingly, the strongback 25 includes a through-hole that fluidly connects gate-engage passageway 91 with the upper port of support passageway 37, and a through-hole (not shown) which fluidly connects gate-disengaging passageway 92 with the lower port of support passageway 37′. Comparing FIG. 11 to FIG. 8, the support bellows 38 have contracted as the gate support 35 now lowered.

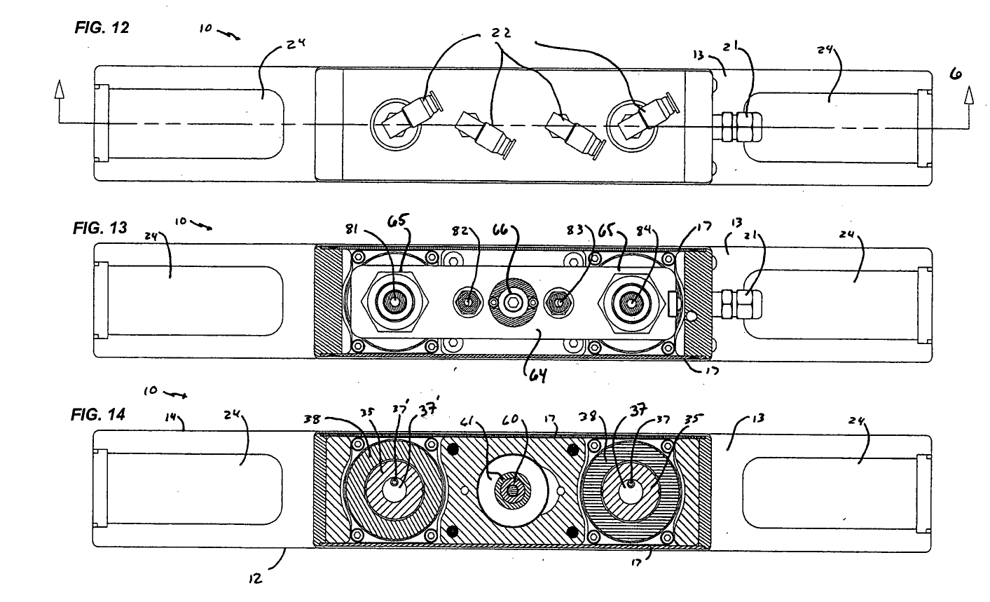

FIG. 12 shows a top view of the valve 10 shown in FIG. 1. Pneumatic pressure is applied to the actuators via the valve fittings 22 via suitable means which may be integrated with a wafer processing system or other system in which valve 10 is incorporated.

FIG. 13 shows a cross-section of the valve 10 shown in FIG. 6, taken along the line 13-13 providing a top plan view of cross link 64 and its interconnection with the gate supports 35 and the piston rod 60 by way of support nuts 65 and a piston rod bolt 66. Pneumatic pressure may be applied through the fittings (22 in FIG. 12) to operate valve 10 and, in particular, through 81 to disengage the valve gate, through conduit 82 to raise the valve assembly, through the conduit 83 to lower the valve assembly, and through conduit 84 to engage the valve gate, as desired.

FIG. 14 shows a cross-section of the valve 10 shown in FIG. 6, taken along the line 14-14. As shown in FIG. 14, support bellows 38 surround the gate supports 35 and isolate pressure in the support passageways 37 of the gate supports 35 from the pressure in which the valve 10 is used. Furthermore, support bellows 38 also serve to isolate any particulate generation due to sliding contact of the gate supports 35 from the valve chamber 33.

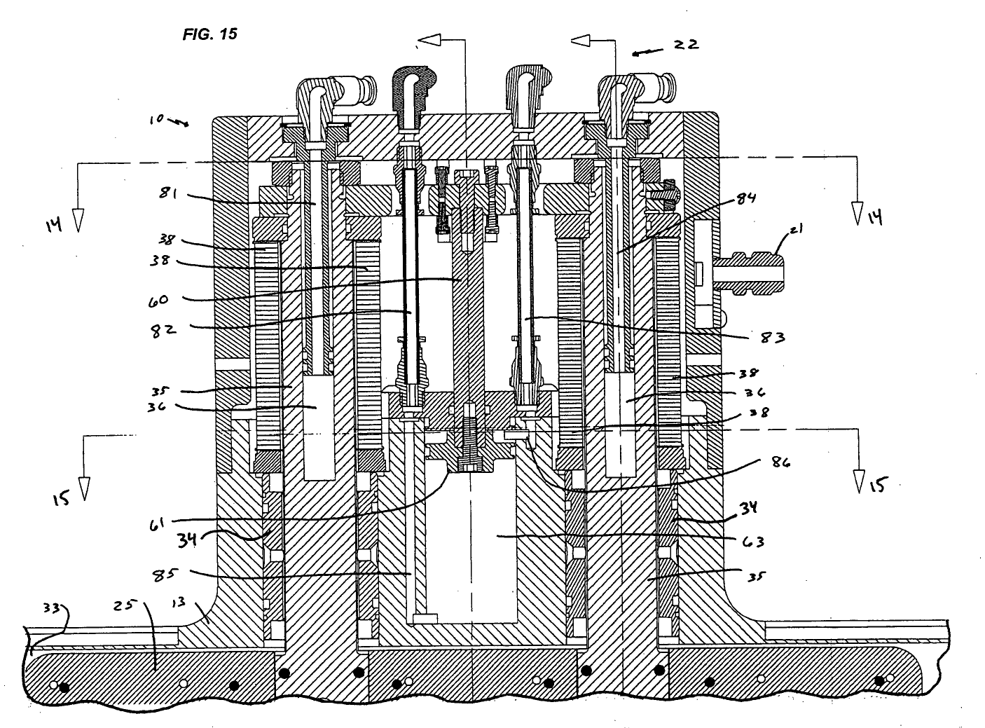

FIG. 15 shows an enlarged, more detailed view of an upper portion of the cross-section of the valve 10 shown in FIG. 6, with the valve 10 in the open position. Open conduit 82 is fluidly connected to the piston chamber 63 by first housing passageway 85. Pneumatic pressure applied to open conduit 82 urges the valve-support piston 61 upward in the orientation shown, thereby raising the gate 20 and the gate support, and opening the valve 10. Close conduit 83 is fluidly connected to the piston chamber 63 by second housing passageway 86. Pneumatic pressure applied to close conduit 83 urges the valve-support piston 61 downward in the orientation shown, thereby lowering the gate 20 and the gate support, and closing the valve 10.

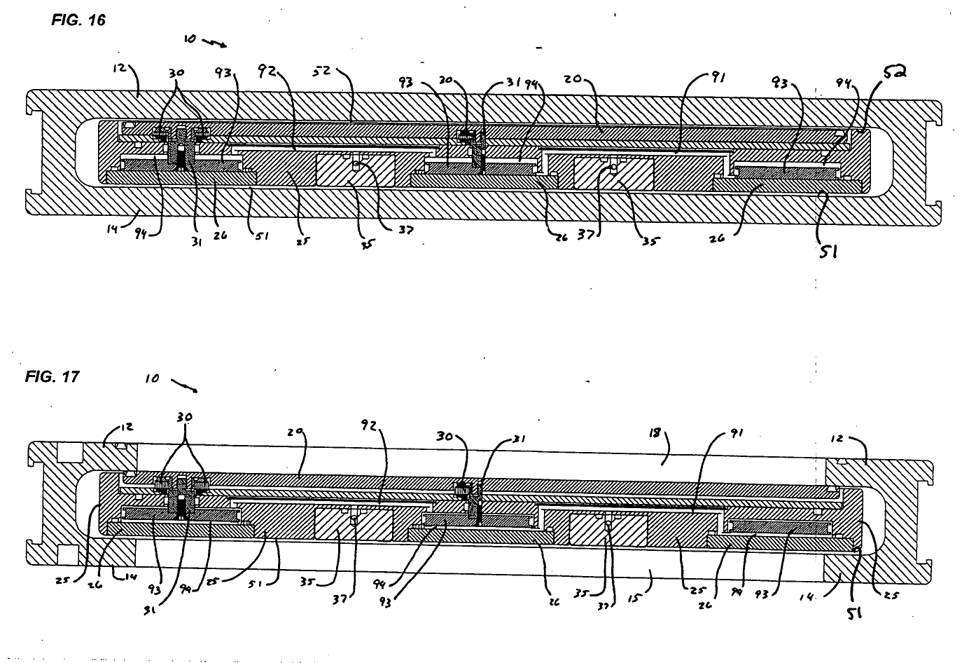

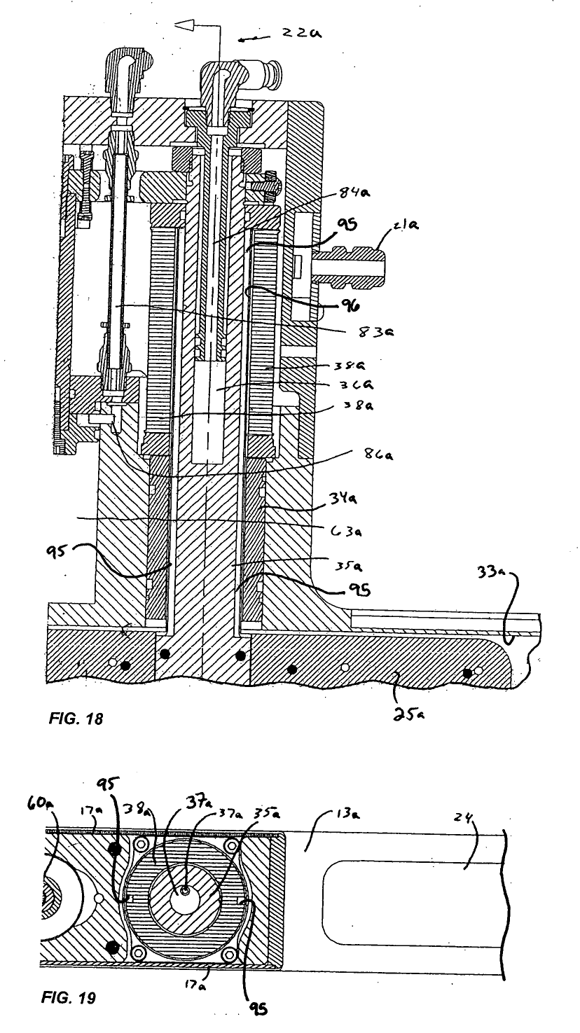

FIG. 16 shows a cross-section of the valve 10 shown in FIG. 6, taken along the line 16-16, with the valve 10 in the open position. As shown in FIG. 18, the right half of the cross-section extends through the upper gate-engaging passageway 91, while the left half of the cross-section extends through the lower gate-disengaging passageway. In the open position, the gate 20 is spaced from the first side 12 of the housing 13 by a space 52. Gate piston rods 31 move laterally relative to the strongback 25 to move the gate 20 toward and away from the first side 12 of the housing 13. In the example of FIG. 16, three gate piston rods 31 are used to control lateral movement of the gate 20 relative to the strongback 25. Gate pistons 93 are connected to the gate piston rods 31 to move within piston chambers 94 in response to pneumatic pressure applied through gate-engaging passageway 91, which feeds the rear half of the piston chambers 94 (lower half as viewed in FIG. 16), and in response to pressure applied to gate-disengaging passageway 92, which feeds the forward half of the piston chambers 94 (upper half as viewed in FIG. 16), in order to move the valve forward (upwardly as viewed in FIG. 16) to seal the valve gate 20, and rearward (downwardly as viewed in FIG. 16) to disengage the valve gate.

Gate bellows 30 expand and contract in response to movement of the gate piston rods 31. As noted above, gate-disengaging passageway 92 is fluidly connected to disengage conduit 81 via support passageway 37′ in the left-hand gate support 35. Gate-disengaging passageway 92 is fluidly connected to chambers 94 of each of the three pistons 93, in this example. Pressure through passageway 92 urges the gate 20 into the closed position spaced away from the first side 12 of the housing 13 by a space 52 by urging the gate pistons 93 and the attached gate piston rods 31 toward the second side 14 of the housing 13 in the example shown. Gate-engaging passageway 91 is fluidly connected to engage conduit 84 (see FIG. 6) via support passageway 37 in right-hand the gate support 35. Gate-engaging passageway 91 is fluidly connected to chambers 94 of each of the three pistons 93, in this example. Pressure through conduit 91 urges the gate 20 into the closed position in which the gate 20 seals against the first side 12 of the housing 13, as described further herein.

With continued reference to FIG. 16 gate-disengage passageway 92 is used as a part of the second actuator to open the valve 10. In the open position of the valve 10, gate-disengage passageway 92 is providing pressure to the piston chambers 94 to urge the piston actuators 93 toward the second side 14 of the housing 13. The gate 20 is spaced from the first side 12 of the housing 13 by a space 52 when the valve 10 is in the open position. The strongback 25 is spaced from the second side 14 of the housing 13 by space 51 in both the open and closed positions of the valve 10.

With further reference to FIG. 16, gate-disengage passageway 91 is used as a part of the second actuator to close the valve 10. In the open position, the gate-disengage passageway 91 is used to exhaust pressure from the piston chambers 94.

FIG. 17 shows a cross-section of the valve 10 shown in FIG. 9, taken along the line 17-17, with the valve 10 in the closed position. In the open position, the gate 20 is pressed against the first side 12 of the housing 13 to seal the first opening 18. Gate piston rods 31 move laterally relative to the strongback 25 to move the gate 20 toward and away from the first side 12 of the housing 13. In the example of FIG. 17, three gate piston rods 31 are used to control lateral movement of the gate 20 relative to the strongback 25. Gate pistons 93, connected to the gate piston rods 31, move within piston chambers 94 in response to pneumatic pressure applied through passageways 91, 92. Gate bellows 30 expand and contract in response to movement of the gate piston rods 31, and are expanded in the closed position of the valve 10. Passageway 91 is fluidly connected to chambers 94 of each of the three pistons 93, in this example. Pressure through conduit 91 urges the gate 20 into the closed position in which the gate 20 seals against the first side 12 of the housing 13.

With continued reference to FIG. 17, disengage passageway 92 is used as a part of the second actuator to open the valve 10. In the closed position of the valve 10, gate-disengage passageway 92 is used to exhaust pressure from the piston chambers 94.

With further reference to FIG. 17, gate-engage passageway 91 is providing pressure to the piston chambers 94 to urge the piston actuators 93 toward the first side 12 of the housing 13 to seal the first opening 18. The strongback 25 is spaced from the second side 14 of the housing 13 by space 51 in both the open and closed positions of the valve 10. To maintain the space 51 between the strongback 25 and the second side 14 of the housing 13, the strongback 25 and the gate supports 35 are sufficiently rigid to accommodate the pressure of the gate piston rods 31 pushing the strongback 25 to seal the gate 20 against the first opening 18 without deflecting the strongback 25 into the second side 14. By maintaining the space 51, the valve 10 minimizes contact between moving parts internal to the valve 10, thereby minimizing particulates that could be introduced into the modules through such contact.

In another embodiment of the present invention, valve 10a is similar to valve 10 described above but includes a modified thrust bearing/gate support configuration, as shown in FIG. 18 and FIG. 19. Like reference numerals have been used to describe like components of valve 10a and 10b. In this embodiment, gate support 35a includes one or more longitudinal grooves 95 which provide an exhaust passageway allowing a path for fluid to enter and exit from the space 96 within support bellows 38a as the bellows expands and contracts. In the illustrated embodiment, gate support 35a includes a pair of diametrically opposed grooves, however, one will appreciate that one, two, three or more grooves may be provided. One will further appreciate that the circumferential spacing of such exhaust grooves may vary or may be equidistant from one another.

In this embodiment, valve 10a also includes modified thrust bearings 34a do not have countersunk ends as compared to thrust bearings 34 described above. The non-countersunk configuration increases the sliding contact area, and namely the axial length of sling contact between gate supports 35a and thrust bearings 34a, thereby providing a longer moment arm, which serves to further minimize transverse flexing (e.g., front to back flexing) of the gate supports 35a, By minimizing transverse flexing, this configuration also serves to further prevent contact between the strongback 25a with the valve housing 13a. In operation and use, valve 10a is used in substantially the same manner as valve 10 discussed above.

In many respects the modifications of the various figures resemble those of preceding modifications and the same reference numerals followed by subscripts “a” designate corresponding parts.

For convenience in explanation and accurate definition in the appended claims, the terms “up” or “upper”, “down” or “lower”, “left” and “right” are used to describe features of the present invention with reference to the positions of such features as displayed in the figures.

Although the present invention has been described with respect to particular embodiments thereof, variations are possible. The present invention may be embodied in specific forms without departing from the essential spirit or attributes thereof. It is desired that the embodiments described herein be considered in all respects illustrative and not restrictive and that reference be made to the appended claims and their equivalents for determining the scope of the invention.

What is claimed is:

1. A gate valve comprising:
a valve housing that defines a valve chamber having first and second side walls and respective first and second aligned openings therein for unobstructed passage along a flow path through said first and second side walls;
a gate support reciprocable within said valve housing between a first support position remote from said openings and a second support position between said openings;
a valve gate carried on said gate support and transversely reciprocable between a first gate position spaced from said first side wall and a second gate position abutting against and sealing off said first opening;
a first actuator within said valve chamber that moves said gate support between said first and second support positions; and
a second actuator carried on said gate support that moves said valve gate between said first and second gate positions,
wherein said gate support is spaced apart from said second side wall of said housing when said valve gate is in said first and second gate positions.

2. The gate valve of claim 1, wherein said gate support is longitudinally reciprocable within said valve housing between said first support position and said second support position.

3. The gate valve of claim 1, wherein said valve housing comprises:
a first housing portion that is a monolithically formed piece of material that forms said first and second side walls having said first and second openings, respectively, defined therein; and
a second housing portion that detachably connects to a lower end of said first housing portion to form a bottom plate that provides access to said valve chamber when said second housing portion is removed from said first housing portion.

4. The gate valve of claim 1, wherein said second actuator comprises a first pneumatic actuator to seat and unseat said valve gate into and out of engagement about said first opening.

5. The gate valve of claim 4, wherein said second actuator comprises an expandable bellows mounted at one end thereof to said gate support and mounted at another other end thereof to said valve gate to isolate moving components of said actuator from said valve chamber.

6. The gate valve of claim 1, wherein said first actuator is double acting pneumatic actuator to move said gate support between said first and second support positions.

7. The gate valve of claim 6, wherein said first actuator comprises a first conduit that supplies pneumatic pressure to move said gate support from said first support position to said second support position and a second conduit that supplies pneumatic pressure to move said gate support from said second support position to said first support position.

8. The gate valve of claim 1, wherein said first actuator comprises a piston assembly operably connected to said gate support for moving said gate support between said first and second support positions in response to pneumatic pressure applied to said piston assembly.

9. The gate valve of claim 1, wherein said gate support comprises a support passageway for providing pneumatic pressure to said second actuator.

10. The gate valve of claim 9, wherein said gate support comprises first and second gate support shafts operably connected to said first actuator, and first and second support passageways defined in said first and second gate support shafts, respectively, for providing pneumatic pressure to said second actuator, wherein said first support passageway provides pressure to move said valve gate from said first gate position to said second gate position and said second support passageway provides pneumatic pressure to move said valve gate from said second gate position to said first gate position.

11 The gate valve of claim 10, wherein said gate support further comprises a strongback fixedly connected to said gate support shafts, wherein said valve gate is reciprocally mounted on said strongback by said second actuator such that said valve gate moves transversely toward and away from said strongback when said gate moves between said first and second gate positions, and wherein gate support shafts and said strongback are sufficiently rigid to prevent said gate support shafts from contacting said second side wall of said housing in response to movement of said gate into said second gate position.

12. The gate valve of claim 9, further comprising an expandable bellows that isolates said second actuator from said valve chamber.

13. A gate valve comprising:
a valve housing that defines a valve chamber having first and second side walls and respective first and second aligned openings therein for unobstructed passage along a flow path through said first and second side walls, wherein said first and second side walls are monolithically formed;
a gate support reciprocable within said valve housing between a first support position remote from said openings and a second support position between said openings;
a valve gate carried on said gate support and transversely reciprocable between a first gate position spaced from said first side wall and a second gate position abutting against and sealing off said first opening;
a first actuator within said valve chamber that moves said gate support between said first and second support positions; and
a second actuator carried on said gate support that moves said valve gate between said first and second gate positions.

14. The gate valve of claim 13, wherein said gate support is spaced apart from said second side wall of said housing when said valve gate is in said first and second gate positions.

15. The gate valve of claim 14, wherein said second actuator comprises a plurality of piston assemblies that reciprocally connect said valve gate to said gate support and move said valve gate between said first and second gate positions in response to pneumatic pressure applied to said piston assemblies, and wherein said gate support comprises a gate support shaft and a strongback that that sufficiently rigid to prevent said gate support from flexing and contacting said second side wall of said housing when said piston assemblies exert a force against said gate support to move said valve gate into said second gate position.

16. A gate valve comprising:
a two-piece valve housing that defines a valve chamber, said housing comprising
a first housing piece monolithically formed from a single piece of material that forms first and second parallel side walls, said side walls having defined therein first and second aligned openings, respectively, wherein said first and second openings form a central opening in said valve that allows an unobstructed passage between said first side wall and said second side wall along a flow path, and
a second housing piece that forms a bottom plate detachably connected to a lower end of said first housing piece, wherein removal of said second housing piece provides access to said valve chamber;
a valve gate that reciprocates between open and closed gate positions of said gate valve, wherein said valve gate is positioned in said central opening in sealing contact with said first side wall of said housing to cover said first opening when said valve is in a closed position, and wherein said valve gate is positioned remote from said central opening and spaced apart from said first side wall of said housing when said valve is open;
a first actuator that moves said valve gate between a first support position in said central opening and a second support position remote from said central opening;
a second actuator that moves said valve gate between a first position in sealing contact with said first side wall of said housing wherein said first opening is covered and a second position wherein said gate is spaced apart from said first side wall of said housing; and
a gate support that supports said valve gate, wherein said gate support is spaced apart from said housing when said valve is in said open and closed positions.

17. The valve gate of claim 16, wherein said gate support comprises a strongback, and wherein said second actuator connects said gate to said strongback and moves said gate away from said strongback to a closed gate position in which said gate engages said first side wall of said housing proximate said first opening and toward said strongback to an open gate position in which said gate disengages said first side wall of said housing.

18. The valve gate of claim 17, wherein said second actuator comprises:
a plurality of piston assemblies connecting said valve gate to said gate support;
first and second conduits that provide pneumatic pressure to move said gate between said open and closed gate positions; and
expandable metal bellows that isolate pressure in said second actuator from atmospheric pressure in which said valve operates.

19. The valve gate of claim 16, wherein said first actuator comprises means for moving said gate longitudinally within said valve chamber between a first support position in said central opening and a second support position remote from said central opening.

20. The valve gate of claim 16, wherein said first actuator comprises a piston assembly that moves said gate support longitudinally within said valve chamber between said first and second support positions in response to pneumatic pressure applied to conduits in fluid communication with said piston assembly.
